(19) United States
(12) Patent Application Publication
(10) Pub. No.: US 2010/0332311 A1
(43) Pub. Date: Dec. 30, 2010

(54) SYSTEM AND METHOD FOR APPORTIONING MARKETING RESOURCES

(76) Inventor: David J. Jilk, Boulder, CO (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/491,996

(22) Filed: Jun. 25, 2009

(51) Int. Cl. G06Q 30/00

(52) U.S. Cl. 705/14.42; 705/14.45; 705/14.46; 705/14.48; 705/14.52

(57) ABSTRACT

Provided in some embodiments is a method of apportioning marketing resources. The method in some embodiments includes storing a marketing objective for a marketing metric, storing a plurality of marketing allocation options, storing one or more piecewise linear response functions of the marketing metric versus one or more of the plurality of marketing allocation options, providing to a computer system a linear problem incorporating one or more special ordered sets and based at least in part on the marketing objective, one or more of the plurality of marketing allocation options, and one or more of the piecewise linear response functions, and solving the linear problem to generate a solution indicative of an apportionment of marketing resources among marketing allocation options that satisfies the marketing objective. In some embodiments, marketing resources can be allocated based on the solution.

### BACKGROUND

1. Field of the Invention

The present invention generally relates to systems and methods for apportioning marketing resources and more particularly to the use of certain mathematical techniques to assess and determine an apportionment of marketing resources to attain certain objectives.

2. Description of Related Art

Large companies often spend tens or hundreds of millions of dollars a year in marketing allocations (e.g., spending) in an attempt to present their message to the public, and many companies large and small spend a significant fraction of their revenues in such endeavors. Marketing allocations traditionally include spending on advertisements directed to consumers and/or political messages or campaigns. It is well documented that such advertisements help persuade their audience to purchase a product, help to increase brand awareness and/or help to raise awareness of certain issues. Traditional forms of advertisement media include television, radio, magazines, newspapers, flyers, mailings, internet advertisements, e-mails, billboards, telemarketing, and the like.

It is generally believed that the more resources one expends on marketing, the more awareness or sales one should expect in return. Unfortunately, a straightforward relationship between the expenditure of marketing resources and actual returns is not always true, and furthermore the actual relationship may vary based on any number of external factors. To address these concerns companies often employ marketing research departments or outside agencies that analyze data available to them in an attempt to determine the effects of certain forms of marketing, and in-turn to develop an effective marketing campaign. For instance, marketing personnel may attempt to correlate sales and profits to certain areas of marketing spending in an attempt to guide an effective apportionment of such spending.

Numerous techniques are available for measuring the effect of marketing on business success. For example, Marketing Mix Modeling attempts to determine the impact of variations of spending in particular advertising media categories (e.g., television, online, magazine, and others) on unit sales, revenue, or market share. Carefully designed survey experiments that separate test and control groups are often used to measure the differential impact of specific marketing tactics (including media selections, creative approach, market segment targeting, timing, and others) on brand attitudinal metrics such as unaided awareness, perceived product relevance, or intent to purchase. Further, correlative regression techniques can be applied to any combination of marketing tactics and business metrics to derive a putative relationship. These and other measurement techniques have often been applied to evaluate past marketing efforts, and they are increasingly used as a component of a planning process that attempts to improve the overall return on investment in marketing. A common output of Marketing Mix Modeling, for example, is a recommended change in the apportionment of marketing spending that, based on the predictions of the model, either produces the same net results with less spending, or better results with the same spending.

In situations where the purpose of a marketing effort is to maximize or meet a specific goal for a single business metric, an optimal apportionment of resources can sometimes be determined without difficulty. For example, the solution can be found analytically using algebra, by inspection, with heuristics, or a combination thereof. In some cases, however, the applicable optimization problem is too complex for such ad-hoc solutions. For example, some campaigns involve multiple objectives that are captured by different metrics. Furthermore, if there are many marketing options to consider and more particularly if those options exclude each other in various ways, the solution methods described above may become increasingly difficult. Consequently, these methods may be inadequate for use with more complex apportionment optimization problems.

Accordingly, there is a desire for a technique that can be used to provide an accurate guide to apportioning marketing resources based on one or more objectives.

### SUMMARY

Various embodiments include a method of apportioning marketing resources. One such method includes storing a marketing objective for a marketing metric in a first computer memory location, storing a plurality of marketing allocation options in a second computer memory location, storing one or more piecewise linear response functions of the marketing metric versus one or more of the plurality of marketing allocation options in a third computer memory location, providing to a computer system a linear problem that incorporates one or more special ordered sets and based at least in part on the marketing objective, one or more of the plurality of marketing allocation options, and one or more of the piecewise linear response functions, and solving, using a computer, the linear problem to generate a solution indicative of an apportionment of marketing resources among marketing allocation options that satisfies the marketing objective.

In another embodiment, provided is a computer readable storage medium having program instructions stored thereon that are computer-executable to implement a method of apportioning marketing resources. The method includes storing a marketing objective for a marketing metric, storing a plurality of marketing allocation options, storing one or more piecewise linear response functions of the marketing metric versus one or more of the plurality of marketing allocation options, providing a linear problem that incorporates one or more special ordered sets and based at least in part on the stored marketing objective, one or more of the plurality marketing allocation options, and one or more of the piecewise linear response functions, and solving the linear problem to generate a solution indicative of an apportionment of marketing resources that satisfies the marketing objective and marketing.

In yet another embodiment, provided is a system for determining an apportionment of marketing resources. The system includes a CPU, a data memory coupled to the CPU, and a system memory coupled to the CPU. The system memory can be used to store one or more computer programs executable by the CPU. The computer programs are executable to implement a method that includes storing a marketing objective for a marketing metric, storing a plurality of marketing allocation options, storing one or more piecewise linear response function of the marketing metric versus one or more of the plurality of marketing allocation options, providing a linear problem that incorporates one or more special ordered sets and based at least in part on the stored marketing objective, one or more of the plurality marketing allocation options, and one or more of the piecewise linear response functions, and solving the linear problem to generate a solution indicative of an apportionment of marketing resources that satisfies the marketing objective.

Provided in another embodiment is a method of apportioning marketing resources. The method includes receiving one or more marketing objectives, receiving a plurality of response functions indicative of marketing metric values as a function of a marketing allocation option, translating one or more of the plurality of response functions each into a response function of a piecewise linear form, providing a linear problem based at least in part on at least one of the one or more marketing objectives and one or more of the response functions of piecewise linear form, providing the linear optimization problem to linear programming solver software, executing linear programming solver software to solve the linear optimization problem, determining an actual allocation amount for one or more marketing allocation options associated with the plurality of response functions based on a solution of the linear optimization problem, and apportioning marketing resources based on the determined actual allocation amount for the one or more marketing allocation options associated with the plurality of response functions.

Provided in yet another embodiment, is a method of apportioning marketing resources. The method includes providing a marketing objective function, providing a first response function for a metric having a first set of metric response values that correspond to a first set of allocation amounts for a first marketing allocation option, translating the first response function into a piecewise linear form including a plurality of first linear components, wherein each of the plurality of first linear components includes a discrete response function value for an associated allocation amount multiplied by a weighting variable, and wherein the summation of the weighting variables for each of the plurality of first linear components is less than or equal to a value of one. The method also includes providing a second response function for the metric having a second set of metric response values that correspond to a second set of allocation amounts for a second marketing allocation option, translating the second response function into a piecewise linear form including a plurality of second linear components, wherein each of the plurality of second linear components includes a discrete response function value for an associated allocation amount multiplied by a weighting variable, wherein the summation of the weighting variables for each of the plurality of second linear components is less than or equal to a value of one. The method also includes calculating a solution set using a special ordered set of type two based on the marketing objective function. This includes calculating a first plurality of solution values, wherein each of the first plurality of solution values corresponds to a weighting variable for each of the plurality of first linear components, wherein the summation of the weighting variables for each of the plurality of first linear components is less than or equal to a value of one, wherein not more than two of the weighting variables for each of the plurality of first linear components are non-zero, and wherein the not more than two of the weighting variables for each of the plurality of first linear components that are non-zero are adjacent to one another when arranged with respect to their associated allocation amounts. Calculating a solution set also includes calculating a second plurality of solution values, wherein each of the second plurality of solution values corresponds to a weighting variable for each of the plurality of second linear components, wherein the summation of the weighting variables for each of the plurality of second linear components is less than or equal to a value of one, wherein not more than two of the weighting variables for each of the plurality of second linear components are non-zero, and wherein the not more than two of the weighting variables for each of the plurality of second linear components that are non-zero are adjacent to one another when arranged with respect to their associated allocation amounts. The method also includes calculating an allocation solution. This includes calculating a first allocation solution for a first marketing allocation option, including summing the products of each of the first plurality of solution values and an associated allocation amount of the first set of allocation amounts. Calculating an allocation solution also includes calculating a second allocation solution for a second marketing allocation option, including summing the products of each of the second plurality of solution values and an associated allocation amount of the second set of allocation amounts.

### BRIEF DESCRIPTION OF THE DRAWINGS

Advantages of the present invention will become apparent to those skilled in the art with the benefit of the following detailed description and upon reference to the accompanying drawings in which:

FIG. 1 is a plot that illustrate functions of exemplary special ordered sets in accordance with the prior art.

FIG. 2 is a flowchart that illustrates a method of apportioning marketing resources in accordance with one or more embodiments of the present technique.

FIG. 3 is a flowchart that illustrates a method of providing response functions in accordance with one or more embodiments of the present technique.

FIG. 4 is a flowchart that illustrates a method of translating response functions to piecewise linear form in accordance with one or more embodiments of the present technique.

FIG. 5 is a flowchart that illustrates a method of constructing a linear optimization problem in accordance with one or more embodiments of the present technique.

FIG. 6 is a diagram that illustrates a computer system in accordance with one or more embodiments of the present technique.

FIGS. 7A-7D depict listings of the inputs for exemplary analysis/cases in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique provide for solving marketing resource apportionment problems using a generally consistent approach. It is believed that the present technique may be useful for solving complex marketing resource apportionment problems and similar problems rapidly. The technique, in certain embodiments, includes collection of marketing response data, preparation of marketing response relationships in a canonical form, translation of the marketing response relationships in a canonical form into a solvable form, use of certain linear programming techniques to assess and determine a solution based on certain objectives, and translation of the solution to a form of marketing response variables, such as monetary amounts of marketing spending.

In certain embodiments, the technique includes the use of special ordered sets, such as special ordered sets of type one and/or two. Linear optimization problems that include special ordered sets may be solved using linear programming methods and may be particularly well suited for use with discrete data sets. Linear programming methods may provide for finding solutions quickly as the problem size increases in scale (e.g., as more data and/or an increasing number of objectives is provided). Further, the use of discrete data sets with linear programming techniques may not rely on a best-fit curve and thus may be particularly well suited for use with discrete data sets often associated with marketing data.

Special ordered sets may include special ordered sets of type one and special ordered sets of type two. A Special Ordered Set of type One (SOS1) is defined to be a set of variables for which not more than one member from the set may be non-zero in a feasible solution. All such sets are mutually exclusive of each other, the members are not subject to any other discrete conditions and are grouped together consecutively in the data. For example, one use of an SOS1 may include representing a set of mutually exclusive marketing allocation options (e.g., marketing spending options), such as advertisements of different sizes in the same printed publication.

A Special Ordered Set of type Two (SOS2) is a set of consecutive variables in which not more than two adjacent members may be non-zero in a feasible solution. All such sets are mutually exclusive of each other, the members are not subject to any other discrete conditions and each set is grouped together consecutively in the data. SOS2s can make it easier to find global optimum solutions to problems containing piecewise linear approximations to a non-linear function of a single argument.

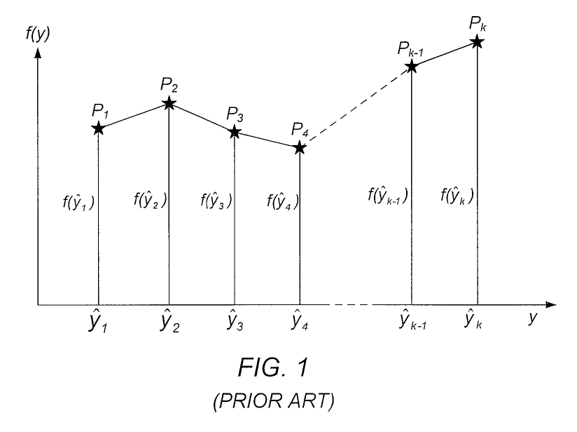

Consider the function ƒ(y) illustrated in FIG. 1 as a piecewise linear function in one variable defined over the closed intervals:

[ŷₖ,ŷₖ₊₁],k=1, . . . , K−1 (1)

where the coordinates (ŷₖ, ƒ(ŷₖ)),k=1, . . . , K, represent points P₁, . . . , P_{K}. Any point y in the closed interval [ŷₖ, ŷₖ₊₁] may be written as:

y=xₖŷₖ+xₖ₊₁ŷₖ₊₁ (2)

where

xₖ+xₖ₊₁=1 (3)

and

xₖ,xₖ₊₁≧0 (4)

Similarly, as ƒ(y) is linear in the interval, it can be written as:

ƒ(y)=ƒ(ŷₖ)xₖ+xƒ(ŷₖ₊₁)xₖ₊₁ (5)

This leads to a representation of ƒ(y) using a set of weighting variables, xₖ, k=1, . . . , K, by the equality:

ƒ(y)=ƒ(ŷ₁)i x₁+ƒ(ŷ₂)x₂+ . . . +ƒ(ŷₖ)xₖ (6)

where

ŷ₁x₁+ŷ₂x₂+ . . . +ŷₖxₖ−y=0,y≧0 (7)

x₁+x₂+ . . . +xₖ=1, xₖ≧0, k=1,2, . . . , K (8)

Also, the added condition that not more than two adjacent variables can be non-zero at any one time. The weighting variables xₖ are called the special ordered set type two variables and the rows (6), (7), and (8) are called function rows, reference rows and the convexity rows respectively. Should the SOS2's not represent separable functions then none of these rows need actually exist, but there is generally an advantage to a linear programming solver system if it is aware of the reference rows at least.

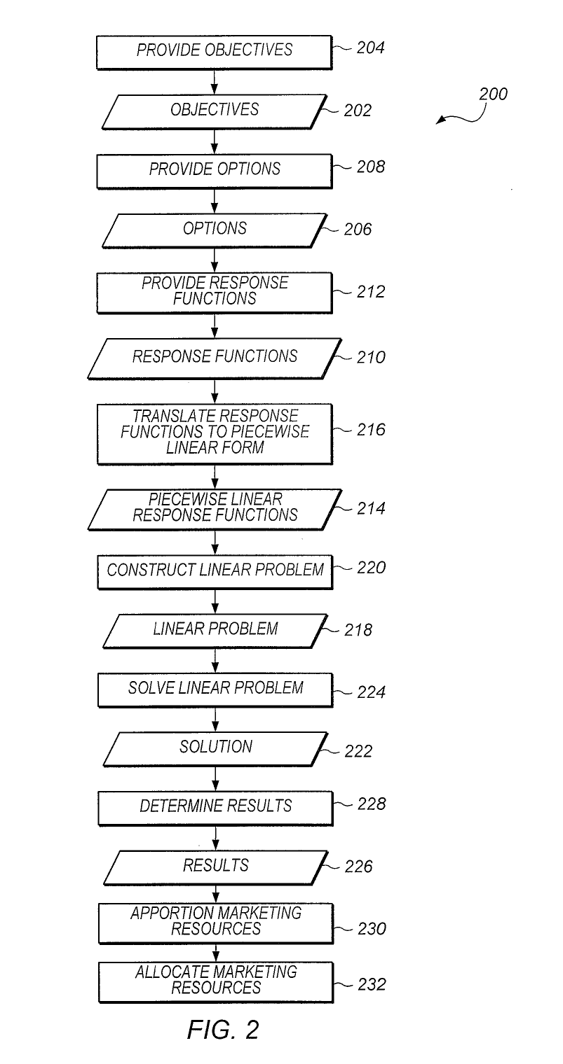

Turning now to FIG. 2, depicted is a flowchart that illustrates a method 200 of apportioning marketing resources among marketing allocation options in accordance with one or more embodiments of the present technique. In one embodiment, method 200 generally includes providing objectives, options and response functions, translating the response functions to a piecewise linear form, constructing a linear problem (e.g., a linear optimization problem) based at least in part on the objectives, options and the response functions, solving the linear problem, and apportioning marketing resources based at least in part on the resulting solution.

Method 200 includes providing objectives 202, as illustrated at block 204. Providing objectives may include designating a particular business metric that is to be affected. For example, the provided objective may include virtually any statistic that relates to the success of the business as a whole or a marketing campaign. Financial metrics such as profit or revenue, tangible marketing metrics such as unit sales or new leads, psychometric brand factors such as unaided awareness or intent to buy, and even unitless metrics associated with subjectively assessed campaign success factors are all examples of possible metrics. Providing objectives may also include designating a goal for each designated metric. The goal can be to maximize the particular metric or to achieve a certain incremental effect on the metric. In certain embodiments, no more than one metric can be designated to be maximized. Determining which metrics should be considered, and what the goals with respect to those metrics should be, may be particular to an organization, a marketing strategy, or the like.

Method 200 includes providing options 206, as illustrated at block 208. Providing options may include designating the marketing tactic allocation options available for the campaign. Options may include the option to apportion marketing resources (e.g., spending) to one or several forms of advertising or other marketing techniques. The allocation options can be at any level of granularity and in any combination, so that the spending category of “television advertising” could be an allocation option, as could “Consumer Magazine, December issue ¼ page color ad.” Allocation options are also not limited to advertising, they could include public relations spending, spending to improve customer service, augmentation of a sales force, and the like. Allocation options can be specific to a customer market segment, a time period, or a particular creative theme. Furthermore, allocations may consist of direct spending, or the application of other resources such as staff time, unused broadcast inventory, and the like. All of the above examples are intended to illustrate the variety of possible spending options and are not a limitation on the spending options that can be designated. It may also be the case that, either to reflect an actual constraint in the world or to reflect policy considerations, some spending options should be treated as mutually exclusive of others. These exclusion policies may also be designated as part of step 208. If applicable, a total allocation ceiling may be designated at step 208. Determining which allocation options should be considered, which of them are exclusive of others, and what (if any) allocation ceiling should be applied, may be particular to an organization, a marketing strategy, or the like.

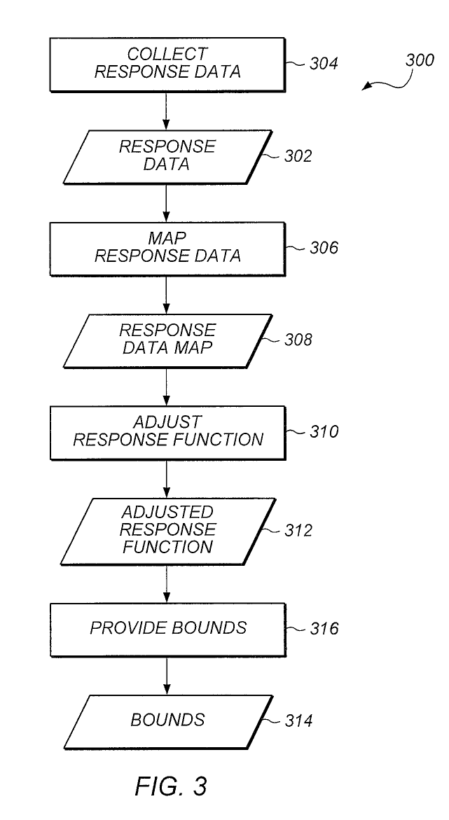

Method 200 includes providing response functions 210, as illustrated at block 212. Providing response functions may include determining a set of response functions such that there is one such response function for each combination of allocation option and metric as designated in steps 204 and 208. For example, a response function may map a metric (e.g., revenue) as a function of an allocation option (e.g., spending in a particular category of advertising). Each such function may meet certain conformance requirements, and the set of functions as a whole may meet certain consistency requirements. An exemplary embodiment of how the response functions may be determined is depicted and described in detail below with respect to FIG. 3.

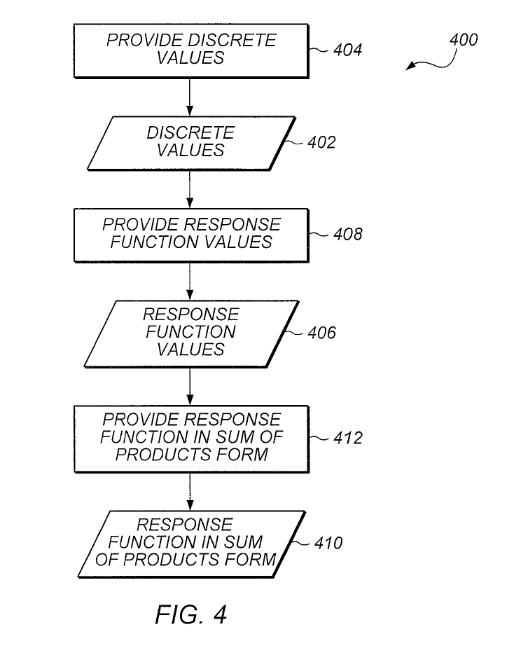

Method 200 includes translating response functions 210 to piecewise linear form (e.g., piecewise linear response functions 214) as depicted at block 216. In one embodiment, such a technique includes translating each response function into a canonical piecewise-linear form. For example, a set of data points may be broken down into, or a function may be approximated by, several consecutive linear functions (e.g., represented by a linear equation in the form y=mx+b) over consecutive intervals. An exemplary embodiment of translating response functions is depicted and described in detail below with respect to FIG. 4.

In one embodiment including values as a function of allocation options, the product of this step may include, for each response function, a finite set of pairs of values of the independent and dependent variables where the value of the dependent variable (y) is equal to the response function of the value of the independent variable (x). These pairs may meet the further condition that for each spending option, the set of spending (x) values is the same. In other words, endpoints of each of the intervals for each piecewise linear function for a particular allocation option share the same spending (x) values.

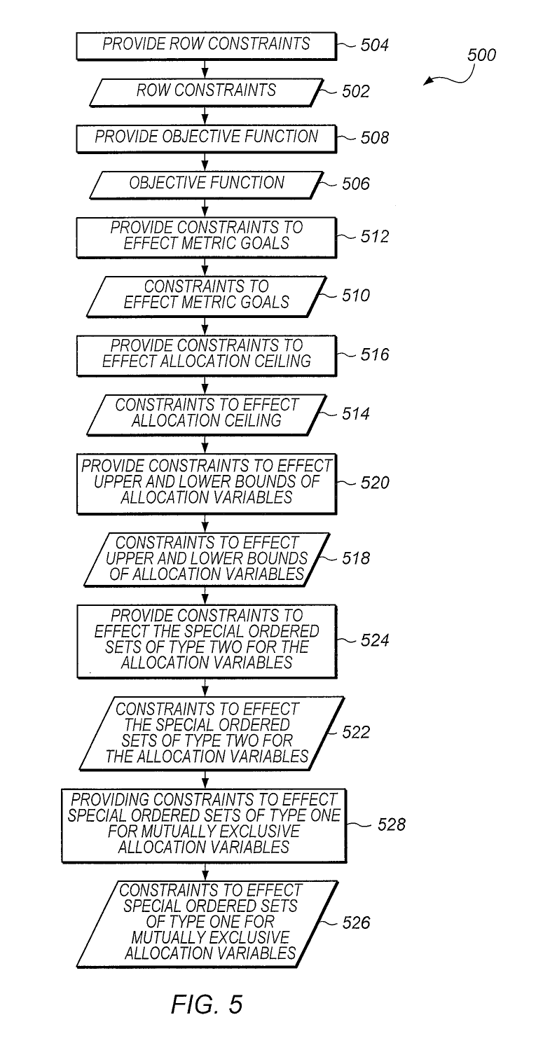

Method 200 includes constructing a linear problem (e.g., a linear optimization problem) 218, as depicted at block 220. In one embodiment, a linear program is constructed based at least in part on the results of the preceding steps and is expressed in a format suitable for input to a linear programming method. An exemplary embodiment of constructing a linear optimization problem is depicted and described in detail below with respect to FIG. 5. In one embodiment, the output of the step constructing a linear optimization problem is an input file for commercially available software. For example, the output may include an input file for use with the open source software known as “LPSolve” available on the World-wide Web at least at <http://sourceforge.net/projects/lpsolve>.

Method 200 includes solving linear optimization problem 218 to determine a solution 222, as depicted at block 224. In one embodiment, solving the linear optimization problem is performed by using the LPSolve open source software. Other embodiments may include the use of other such software, and/or include performing the computations manually (i.e., by hand) using the Simplex method or another applicable algorithm.

It may be possible for solution 222 to include a determination that the linear optimization problem is infeasible or unbounded. Infeasibility can occur when the metric goals cannot all be satisfied due to constraints, such as a total spending limitation and/or upper bounds on individual spending variables, due to response functions being non-increasing above a certain allocation level, or the like. An unbounded result may occur when a metric is maximized and one or more response functions for that metric are unbounded and monotonically increasing. No allocation recommendation may be provided in such cases, and the outcome may be reported directly.

Method 200 includes determining results 226, as depicted at block 228. In one embodiment, providing results includes calculating and reporting actual recommended allocation amounts (e.g., a monetary spending value) for each allocation option, along with the projected value (e.g., a monetary value) of each metric given those allocation amounts. For instance, the results may indicate that based on a three-million dollar budget, two-million dollars should be spent on the television advertisement allocation option and one-million dollars should be spent on the online search advertisement allocation option to meet an objective of maximizing profit. In one embodiment, the allocation amounts are directly available as a subset of the variables in the linear programming problem. However, in some embodiments this may not be the case. In such an embodiment the linear program representation of the allocation variables may be translated back to the original allocation variables. This can be accomplished by applying a reference row equation, as depicted and described in more detail below with respect to step 504 of FIG. 5, to each independent variable. This can also be calculated directly, so that where two adjacent weighting values are provided in a solution, the weighting values may be multiplied by each of their respective allocation amounts, and the results added to one another to provide a total amount for that particular allocation option. Also, in some embodiments, the values of the metrics may be optionally calculated at step 226, by applying each response function to the value of its allocation variable, and then summing these results for each metric.

Method 200 includes apportioning marketing resources, as depicted at block 230. Apportioning marketing resources may be based at least in part on the above described techniques. For example, a company may implement a marketing campaign that includes allocating a monetary amount to one or more forms of advertising based on results 226. Such an embodiment may include for instance, apportioning based on results 226, all of a given budget among television advertisements, online search advertisements, and online banner advertisements. In one embodiment, the amounts from results 226 may be directly followed for the apportionment of marketing resources in each respective allocation option or may be used as a guideline to determine the actual amount of marketing allocations (e.g., monetary amount allocated) for each allocation option (e.g., for each type of advertising). In other embodiments, the amounts in results 226 may be compared against current campaign practices, and the direction of change (e.g., increase or decrease) of each allocation option may be used to determine a direction of change of actual allocation, but not necessarily the precise magnitude of the change. Method 200 also includes allocating marketing resources, as depicted at block 232. Allocating marketing resources is based on the apportionment of marketing resources at block 230, in one embodiment. For example, allocating marketing resources may include actual monetary spending on advertisements directed to consumers and/or political messages or campaigns, based on an assessed apportionment of marketing resources at block 232.

As described briefly above, FIG. 3 depicts a method 300 of providing response functions in accordance with one or more embodiments of the present technique. In one embodiment, method 300 generally includes collecting response data, mapping the response data, adjusting a response function to the same or similar units, and providing bounds (e.g., upper and lower bounds) for the response functions. Method 300 may be implemented within method 200 for apportioning marketing resources in accordance with one or more embodiments of the present technique. Further, the steps of method 300 may be performed for each combination of metric and allocation option.

Method 300 includes collecting response data 302, as depicted at block 304. In one embodiment, collecting response data may include collecting or assembling previously collected data pertaining to the allocation option and its effect on the particular metric. This data can take many forms, and may be acquired directly (e.g., provided in the form of a function) or indirectly (e.g., provided as individual data points that are transformed into a function). For example, in one embodiment, the data could include the outcome of a survey of an audience sample preformed before and after exposure to advertising, with comparison to a control group, along with a known reach/frequency curve for the spending option. In one embodiment, the data could include the output relationships of a Marketing Mix Modeling procedure. Further, in one embodiment, the data could include the average subjective assessment from a “survey of experts” of the effectiveness of the allocation option in relation to the metric. In corporate environments, such data may exist in partial and distributed fashion with different organizational units holding the data for different allocation options or metrics, and thus may be readily available for use in such a technique. In other embodiments, such response data may not be readily available and may be collected specifically for the purpose of applying the present technique.

Method 300 includes mapping response data, as depicted at block 306. In one embodiment, a resulting response data map 308 includes a functional mapping that is a representation of the causal relationship between the amount of allocation on the allocation option and the impact on the metric, and may be determined based on response data 304. In other words, mapping response data may include deriving a functional relationship between a metric and an allocation option (e.g., revenue vs. amount spent on television advertising). In one embodiment, particular approaches can be used for each type of data. For instance, if the response data already includes a defined functional mapping, as may result from a Marketing Mix Model, then that functional mapping may be used with minor or no adjustments. As an example, if the functional mapping includes a logarithmic expression, then the response value may be set to zero for all allocation levels below the point where the logarithmic expression first reaches zero, and the mapping may otherwise be determined based on the values of the logarithmic expression. As a further example, if the functional mapping is a single measurement of impact at one allocation level, then if a reach/frequency curve is available for the allocation option, the function can include a curve that is applied to the measurement at a variety of points. Such curves may often be available as media plans from advertising agencies, or they can be derived from historical measurements. In one embodiment, if a reach/frequency curve is not available, then the functional map may include a linear function proportional to the measured impact.

In an embodiment in which the functional mapping is computed at a variety of points rather than expressed in closed form, a mechanism can be provided for calculating the function at interpolated points. In one embodiment, the function is treated as piecewise linear function such that there are straight lines (e.g., lines expressed in the form y=mx+b) between the end points of each respective interval. In another embodiment, curves may be estimated or a polynomial function fit to the points. In cases where discrete points form the basis of the function, the value of the independent variable at these points may be retained for future processing. In any of the above cases, the response data map 308 generally includes a functional relationship between an allocation option and a metric over a domain of interest.

In some embodiments, each response function may meet the following four conformance requirements:
1) It maps real numbers to real numbers;
2) Its independent variable represents the amount of allocation on the particular allocation option, and its dependent variable represents an incremental effect on the metric;
3) It is single-valued, i.e., for any value of the independent variable there is no more than one associated value of the dependent variable;
4) It is continuous within the domain of the independent variable.

Method 300 also includes adjusting a response function, as depicted as block 310. In one embodiment, resulting adjusted response functions 312 may meet at least the following two consistency requirements:
1) The independent variable has the same unit of measure for all response functions (e.g., dollars, millions of dollars, billions of yen, or gross ratings points);
2) For all response functions where the dependent variable represents the same metric, the dependent variable has the same unit of measure (e.g., dollars, percentage of audience, unitless scale ranging from zero to ten).

In certain embodiments, no adjustments may be necessary or performed at this step. For instance, the mapped data of two or more functions may already share the same or similar units. In other embodiments, the adjustments may be made to bring scales to the same order of magnitude (e.g., thousands of dollars vs. dollars or millions of dollars), or to convert different currencies using an exchange rate, for instance. In still other embodiments, response functions may use different types of measures, such as National Gross Ratings Points (GRPs) for television allocations vs. dollars for online allocations, or unit sales vs. dollar sales for a metric. In such embodiments, a conversion factor may be determined by averaging data or by using a standard value for such components as cost per GRP or sale price per unit. The resulting variables may not always include currency units—although the allocation variables may all use the same units.

Method 300 includes providing bounds 314, as depicted at block 316. In one embodiment, providing bounds includes determining any upper and lower bounds for the domain of the independent variable in each response function. In one embodiment, these bounds may be based on the source data. For example, a Marketing Mix Model may typically include an upper and lower bound within which it has validity. For instance, the source data may have been taken over a given domain, and the response function may not be predictable outside of the domain. In one embodiment, all allocation variables automatically have a minimum of zero, and the metric effect is assumed to be zero at that point. In one embodiment, the most restrictive domain for each independent variable over all of its applicable response functions may be the domain of that independent variable for purposes of the solution. For instance, if the data is valid over a narrow domain for one response function, all of the response functions may be limited to assessment over that narrow domain even if they include valid data outside of the narrow domain.

As described briefly above, FIG. 4 depicts a method 400 of translating response functions 210 to piecewise linear form (e.g., piecewise linear response functions 214), as depicted at block 216, in accordance with one or more embodiments of the present technique. In one embodiment, method 400 generally includes providing discrete spending (x) values for end points of each segment (e.g., interval) of the piecewise linear function, providing a response function value at each of the discrete values, and expressing each response function in a canonical sum of products form.

Method 400 includes providing discrete independent variable values 402, as depicted at block 404. In one embodiment, this includes determining a set of discrete allocation values for each independent variable that will form the endpoints of each piecewise linear segment of the response functions. These values can be determined in a number of ways. In one embodiment, if all the response functions of the independent variable are expressed in closed form, such as y=a ln bx, then we can choose an evenly spaced set of allocation values, such as 0, 1000, 2000, 3000, 4000. In one embodiment, if all of the response functions are based on the combination of a media plan and an impact measurement, for instance, then the allocation points (e.g., spending increments) of the media plan may be a suitable choice for discrete values 402. In one embodiment, if the response functions are already piecewise-linear, but not based on the same set of allocation values, then the overall set of allocation values may be the union of these allocation values across the response functions for that independent variable. Such an approach may avoid creating approximations of the actual known points of the response functions in the piecewise linearization. In one embodiment, a combination of approaches can also be used. For example, the discrete values may be determined by setting a minimum difference between allocation values and adding allocation values between any two values that exceed this minimum difference. This set of discrete values 302 may be definitive for a particular independent variable, and therefore can be identical for each response function including that variable.

Method 400 includes providing response function values 406, as depicted at block 408. In one embodiment, the step may include computing the value of each response function at each of discrete values 402 of the independent variable as determined at step 404. In an embodiment including response functions expressed in closed form, providing response function values may include substituting the discrete value of the independent variable in the expression and computing its value (i.e., its response function value 406). In an embodiment including response functions that are piecewise linear, providing response function values may include computing its value (i.e., its response function value 406) based on the applicable piecewise linear segment. In any case it may be known that these values (i.e., response function values 406) of the response function may be computable based on the conformance requirements provided at step 406. Where a discrete value of an independent variable lies between two or more discrete independent variable values for which a response function value is known, a response function value associated with the intermediate discrete value of an independent variable may be obtained by interpolation (e.g., linear interpolation).

Method 400 includes providing response functions in sum of products form 410, as depicted at block 412. In one embodiment, the response function is expressed in a canonical sum of products form. For instance, if the response points based on discrete independent variable values 402 (shown as sᵢ) and corresponding response function values 406 (shown as rᵢ) are {(s₁,r₁), (s₂,r₂), . . . , (sₙ,rₙ)}, then the function may be expressed in terms of variables v₁, v₂, . . . vₙ as:

Response=r₁v₁+r₂v₂+ . . . +rₙvₙ (9)

In one embodiment, the variables v₁, v₂, . . . , vₙ may only take on values such that:
1) They are real numbers in the range zero to one, inclusive
2) No more than two are non-zero, and if there are two, they must be consecutive/adjacent

As described briefly above, FIG. 5 depicts a method 500 of constructing a linear optimization problem 218 in accordance with one or more embodiments of the present technique, as depicted at block 220, in accordance with one or more embodiments of the present technique. In one embodiment, method 500 generally includes providing row constraints, an objective function, constraints to effect metric goals, constraints to effect an allocation ceiling, constraints to effect upper and lower bounds of allocation variables, constraints to effect the special ordered sets of type two for the allocation variables, and constraints to effect special ordered sets of type one for mutually exclusive allocation variables.

Method 500 includes providing row constraints 502, as depicted at block 504. In one embodiment, providing row constraints includes expressing reference row constraints, of the form:

s₁v₁+s₂v₂+ . . . +sₙvₙ−s=0 (10)

where the s-coefficients are the discrete independent variable values with respect to step 404 and the v-variables are the piecewise-linear allocation variables as described with respect to step 412. Such an embodiment enables the use of original allocation variables within the linear program, and may provide the linear programming solver with additional helpful information for efficient computations.

Method 500 includes providing an objective function 506, as depicted at block 508. In one embodiment, providing an objective function includes expressing an objective function such that if one of the metrics is to be maximized, then the objective is to maximize the sum of the canonical forms of all the response functions for that metric. In another embodiment, the objective function may be expressed to minimize the sum of the allocation variables as defined by the reference row constraints.

Method 500 includes providing constraints to effect metric goals 510, as depicted at block 512. In one embodiment, providing constraints to effect metric goals includes expressing the metric goals as a relation such that the sum of the canonical form of all response functions for the metric is greater than or equal to the goal. In one embodiment, one such constraint may be expressed for each metric for which there is a goal that is not a maximization goal.

Method 500 includes providing constraints to effect allocation ceiling 514, as depicted at block 516. In one embodiment, providing constraints to effect allocation ceiling includes, if there is an allocation ceiling, expressing the ceiling through a relation stating that the sum of the allocation variables, as defined in step 504, is less than or equal to the ceiling.

Method 500 includes providing constraints to effect upper and lower bounds of allocation variables 518, as depicted at block 520. In one embodiment, providing constraints to effect upper and lower bounds of allocation variables includes, if there are lower or upper bounds on any allocation variables, expressing these as relations stating that the allocation variable is greater than or equal to the lower bound, and that it is less than or equal to the upper bound. In one embodiment, a lower bound of zero may not be expressed, because this is the default in a linear program.

Method 500 includes providing constraints to effect the special ordered sets of type two for the allocation variables 522, as depicted at block 524. In one embodiment, providing constraints to effect the special ordered sets of type two for the spending variables includes expressing that the variables in the canonical form of the response functions are a special ordered set of type two, having one such expression for each independent variable. In such embodiment, providing constraints to effect the special ordered sets of type two for the allocation variables further has, for each independent variable, a relation that requires that the sum of the variables in the canonical form of the response functions for that independent variable is less than or equal to one.

Method 500 includes providing constraints to effect special ordered sets of type one for mutually exclusive allocation variables 526, as depicted at block 528. In one embodiment, providing constraints to effect special ordered sets of type one for mutually exclusive allocation variables include, if applicable, expressing that certain allocation variables are mutually exclusive, by indicating that such mutually exclusive allocation variables include a special ordered set of type one. In some embodiments, arbitrary combinations of mutual exclusivity can be included by expressing reference constraints that create new allocation variables that are the sum of others, and then indicating that such combinations of new allocation variables include a special ordered set of type one.

In some embodiments, a range of results may be more valuable than a single solution. In the preferred embodiment, the process detailed above may be operated a number of times at evenly spaced “fractions” ranging from zero to one. In situations where metric goals are specified, the fraction is multiplied by each of the metric goals and the required allocation levels are calculated using the process above. In situations where one metric is maximized, the process may be operated first as a maximization to calculate the maximum value of the metric. This maximum value may then be treated as a goal and the same fraction multiplication approach may be applied. In alternative embodiments, other means of using the process to determine a range of results could be used.

The following discussion provides an exemplary implementation of an embodiment of the previously described technique. In one implementation of the present technique, it may be useful to determine whether or not a given marketing resource apportionment is optimal. For instance, a company may desire to estimate an effectiveness of television advertising in comparison with another form of advertising, such as internet advertising. Accordingly, metrics may be chosen for use in the analysis, such as incremental revenue and incremental profit (revenue minus cost of advertising) due to advertising. Such selection of metrics may be one example of the objectives 202 provided at block 204 of FIG. 2. Further, advertising spending options may be chosen, such as television, online searches and online banner advertising. Such a selection of advertising spending options may be one example of the options 206 provided at block 208 of FIG. 2. In this exemplary embodiment, six response functions may be used (e.g., one response function for each combination of the chosen two metrics and three spending options). These response functions may be readily available directly or may be derived indirectly from various forms of data, as described previously. For example, where incremental unit sales are available for each of the spending options, incremental revenue response (e.g., unit revenue multiplied by unit sales) and profit response (e.g., unit gross profit multiplied by unit sales, minus advertising cost) can be derived. The direct or indirect derivation of the response functions may be one example of providing response functions 210 as provided at block 212 of FIG. 2. Accordingly, in such an embodiment, only incremental unit sales need to be determined for each of the spending options to generate the six response functions.

The response functions may be derived based on certain data that is already available. For example, with respect to online search advertisements, available data may include the cost “per-click” for an on-line search and the probability of a sale from a search related click. For example, the cost per click divided by the probability of a sale provides the incremental cost per sale which can be used in combination with the resulting revenue to provide incremental revenue and incremental profit for online search advertisements. Further, in an embodiment in which there is a maximum number of clicks that can be purchased, the response curve may be bounded at the maximum number of clicks. Accordingly, a response curve for online search advertisements can be provided. For example, the response curve for online search advertisements may be defined by the following:

Unit_Sales=3.5×Online_Search _Spending (11)

where Online_Search_Spending>=$0 and <=$200,000.

With respect to online banners, data may include the probability that a consumer would click through to a website from the banner, the probability that a consumer would interact with the website once they clicked-through to the website, the probability of a sale based on the behavioral outcomes, and the number of unique customers reached at certain spending levels. Accordingly, the analysis could be reduced to a single probability of sale based on the expected number of unique customers reached at each spending level and the probability of a sale. Accordingly, a response curve for online banners can be provided. For example, the response curve for online banner advertisements may be defined by the following sets:

Unit_Sales=7.35×Banner_Ad_Spending (12)

### ,for Banner_Ad_Spending>=$0 and <=$100,000;

Unit_Sales=$7355,000+(4.25×(Banner_Ad_Spending−$100,000)) (13)

### ,for Banner_Ad_Spending>$100,000 and <=$200,000; and

Unit_Sales=$1,160,000+(1.80×(Banner_Ad_Spending−$200,000)), (14)

### ,for Banner_Ad_Spending>$200,000 and <=$300,000.

With respect to television, information may be readily available, including Marketing Mix Model (MMM). In one such example, a MMM for television includes a response of unit sales to television advertising spending as a logarithmic function of the form y=a ln(bx), where a and b are constants, y is unit sales, and x is television advertising spending. For example, the response curve for television advertisements may be defined by the following:

Unit_Sales=$400,000×ln(0.00008×Television_Spending) (15)

where Television_Spending>=$50,000 and <=$250,000.

The derived functions may represent response data maps similar to those discussed with respect to block 308 of FIG. 3. The response functions may be adjusted in a similar manner to that discussed with respect to block 310 of FIG. 3. For example, the three functions of unit sales vs. spending for the three spending options can be used to compute revenue vs. spending and profit vs. spending for each of the three spending options, thereby resulting in six adjusted response functions. In this exemplary embodiment, unit revenue is $1.00 and unit gross profit is $0.50, and these numbers are multiplied by units sales to calculate total revenue and total profit, respectively.

In such an embodiment, the six response functions may then be translated into piecewise linear form if needed, as described above with respect to block 216 of FIG. 2 and FIG. 4. In this exemplary embodiment, the functions for online banner and online search are already provided in piecewise-linear form. Only the functions for television advertising need to be translated into piece-wise linear form. Accordingly, the response function for television advertisement may be translated into piecewise-linear from by computing a value of the analytic function (as derived from the unit sales function) at five evenly spaced spending levels. In this embodiment, the first segment of profit response to television advertising starts at $50,000 with a profit response of $227,259. Accordingly, the point ($50,000, $227,259) is the first point in the respective response curve, with a piecewise-linear profit response function as follows:

Profit=$227,259+$1.77×(TV_Spending−$50,000) (16)

,for TV_Spending from $50,000 to $100,000;

Profit=$315,888+$0.62×(TV_Spending−$100,000) (17)

,for TV_Spending from $100,000 to $150,000;

Profit=$346,981+$0.15×(TV_Spending−$150,000) (18)

,for TV Spending from $150,000 to $200,000; and

Profit=$354,518−$0.107×(TV_Spending−$200,000) (19)

,for TV Spending from $200,000 to $250,000.

In this exemplary embodiment, with each of the functions determined, the profit and revenue for each spending option is represented with a set of weighting variables as provided in equation (9) above, e.g., a linear function of N variables where N is the number of points, and similarly the spending is represented as in equation (10) above. For television profit having five points of ($50,000, $227,259), ($100,000, $315,888), ($150,000, $346,981), ($200,000, $354,518), ($250,000, $349,146) and weighting variables t_{N}, may be represented as:

Television_Profit=$227259t₁+$315888t₂=$346981t₃+$35418t₄+$349146t₅ (20)

Television_Spending=$50000t₁+$100000t₂+$150000t₃+$200000t₄+$2500005t₅ (21)

Similarly, television revenue having five points of ($50,000, $554,518), ($100,000, $831,777), ($150,000, $993,963), ($200,000, $1,109,035), ($250,000, $1,198,293) and weighting variables t_{N}, may be represented as:

Television_Revenue=$554518t₁+$831777t₂=$993963t₃+$1109035t₄+$1198293t₅ (22)

Similarly, online banner advertisement profit having four points of ($0, $0), ($100,000, $267,500), ($200,000, $380,000), ($300,000, $370,000) having weighting variables b_{N} may be represented as:

Banner_Profit=$0b₁+$267500b₂+$380000b₃+$370000b₄ (23)

Banner_Spending=$0b₁+$100000b₂+$200000b₃+$300000b₄ (24)

and online banner advertisement revenue having four points ($0, $0), ($100,000, $735,000), ($200,000, $1,160,000), ($300,000, $1,340,000), having weighting variables b_{N} may be represented as:

Banner_Revenue=$0b₁+$735000b₂+$1160000b₃+$1340000b₄ (25)

Similarly, online search advertisement profit having two points of ($0, $0), ($200,000, $150,000) having weighting variables s_{N} may be represented as:

Search_Profit=$0s₁+$150000s₂ (26)

Search_Spending=$0s₁+$200000s₂ (27)

and online search advertisement revenue having two points ($0, $0), ($200,000, $700,000), having weighting variables s_{N} may be represented as:

Search_Revenue=$0s₁+$700000s₂ (28)

To prepare the equations for use by a linear program solver (e.g., LP Solve), the above information may be translated to construct the linear optimization problem, as discussed previously with respect to block 220 of FIG. 2. For example, for use with LP Solve, three components may be provided, including: (1) an objective function; (2) a set of constraints; and (3) a specification for the special ordered sets. These components may be modified or different based for each type of analysis. For example, in the illustrated embodiment, four separate analyses are performed to determine the following: (1) the spending levels for each of the three options so as to optimize profit; (2) the spending levels to generate maximum profit given a total spending level budget that had been suggested by senior management; (3) the spending level to generate maximum revenue, subject to at least breaking even on the profit; and (4) a sensitivity analysis of the total spending required to achieve a profit that is 90% of the maximum profit.

In this illustrative embodiment, the specification for the special ordered sets remains the same, however, the objective function and constraints vary based on each analysis. For example, for analysis (1), there are no constraints, and the objective function may be expressed as:

Maximize Television_Profit+Banner_Profit+Search_Profit (29)

For analysis (2), the objective function may be expressed as:

Maximize Television_Profit+Banner_Profit+Search_Profit (30)

and the constraints may be expressed as:

Television_Spending+Banner_Spending+Search_Spending<=Budget (31)

For analysis (3), the objective function may be expressed as:

Maximize Television_Revenue+Banner_Revenue+Search_Revenue (32)

and the constraints may be expressed as:

Television_Profit+Banner_Profit+Search_Profit>=0 (33)

For analysis (4), the objective function may be expressed as:

Minimize Television_Spending+Banner_Spending+Search_Spending (34)

and the constraints may be expressed as:

Television_Profit+Banner_Profit+Search_Profit>=(90% of Analysis 1 total) (35)

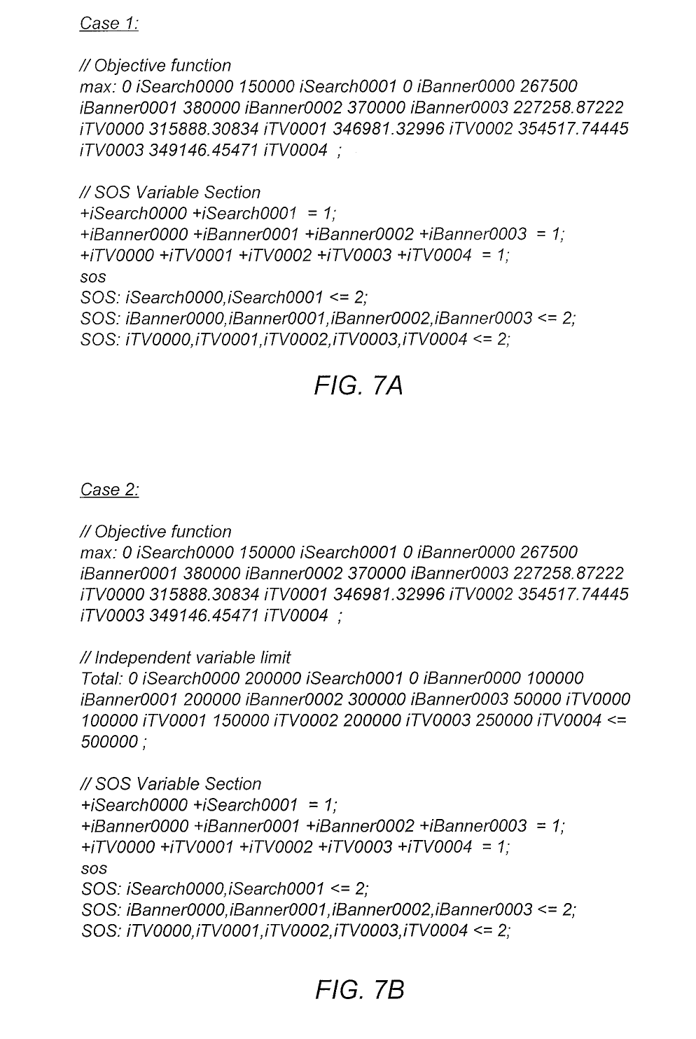

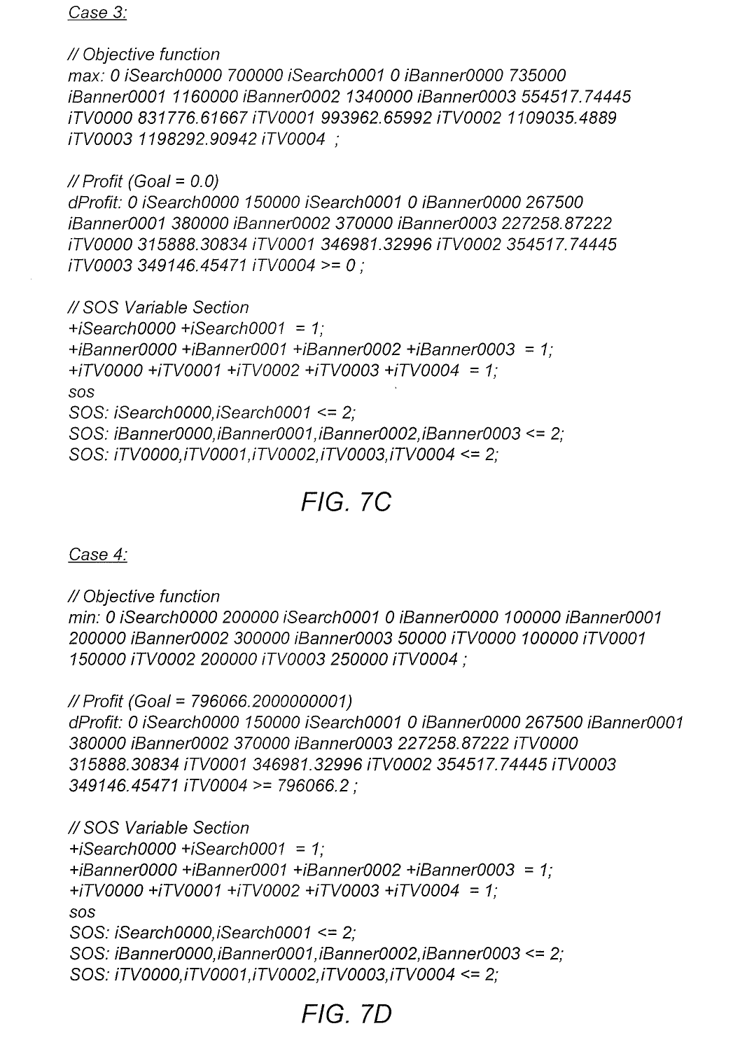

The objective function, set of constraints, and specification for the special ordered sets are input to LP Solve for each of analysis (1)-(4). FIGS. 7A-7D include listings of the inputs for each of the four analysis/cases as input to LP Solve:

The results of the exemplary analysis/cases indicate that:

Case 1: To maximize profit, spend $200,000 on each of TV, Banner, and Search, with a resulting profit of $884,518.

Case 2: To maximize profit subject to a budget of $500,000, spend $200,000 on each of Banner and Search and $100,000 on TV, with a resulting profit of $845,888.

Case 3: To maximize revenue subject to at least breaking even on profit, spend $200,000 on Search, $300,000 on Banner, and $250,000 on TV, with resulting revenue of $3,238,293 and profit of $869,146.

Case 4: To achieve 90% of the maximum profit level with minimum spending, spend $133,571 on Search, $200,000 on Banner, and $100,000 on TV, with resulting profit of $796,066.

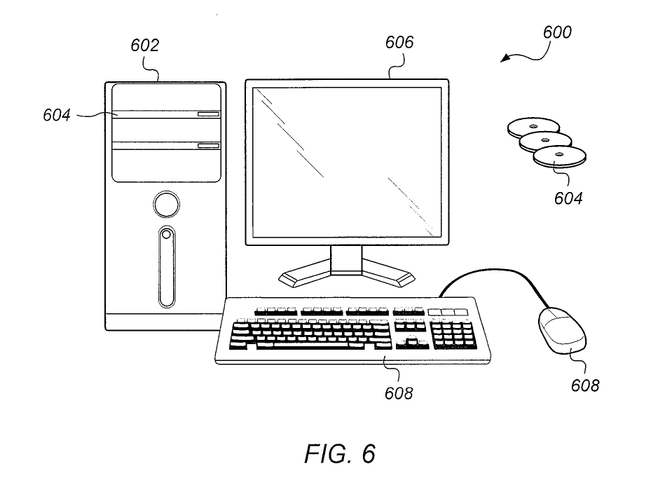

It will be appreciated that the previously described techniques may be implemented on a computer system in certain embodiments. FIG. 6 illustrates an embodiment of computer system 600 that may be suitable for implementing various embodiments of a system and method for assessing and determining allocation of marketing spending. Computer system 600 may include components such as CPU 602 with associated memory medium 604. The term “memory medium” is intended to include computer readable medium, e.g., a CD-ROM or floppy disks, flash memory drives, computer system memory such as DRAM, SRAM, EDO RAM, Rambus RAM, non-volatile memory such as a magnetic media, e.g., a hard drive or optical storage. Memory medium 604 may also include other types of memory or combinations thereof. Memory medium 604 may store program instructions that are executable by CPU 602. Computer system 600 may further include output devices 606 (e.g., a monitor for graphical display), input devices 608 (e.g., an alphanumeric keyboard and/or a directional input device such as mouse). Computer system 600 may be operable to execute the computer programs to implement the above described techniques. Also, computer system 600 may take various forms such as a personal computer system, mainframe computer system, workstation, network appliance, Internet appliance, personal digital assistant (“PDA”), television system or other device. In general, the tern “computer system” may refer to any device having a processor that executes instructions from a memory medium.

Further modifications and alternative embodiments of various aspects of the invention will be apparent to those skilled in the art in view of this description. For instance, although the above includes an example of an analysis for three types of advertising, a similar technique may applied for any given number of metrics, spending options, objectives, constraints, and applicable special ordered sets. Further, an analysis may be formed based on data over varying periods of time. For example, sales and response functions may vary based on seasons, and thus it may be beneficial to create distinct response functions for different periods (e.g., months) of the year to reflect seasonality and such that advertising spending allocation may be varied throughput the year based on the results of the analysis. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to.

What is claimed is:

1. A method of apportioning marketing resources, comprising:
storing a marketing objective for a marketing metric in a first computer memory location;
storing a plurality of marketing allocation options in a second computer memory location;
storing one or more piecewise linear response functions of the marketing metric versus one or more of the plurality of marketing allocation options in a third computer memory location;
providing to a computer system a linear problem incorporating one or more special ordered sets and based at least in part on the marketing objective, one or more of the plurality of marketing allocation options, and one or more of the piecewise linear response functions; and
solving, using a computer, the linear problem to generate a solution indicative of an apportionment of marketing resources among marketing allocation options that satisfies the marketing objective.

2. The method of claim 1, wherein the marketing objective comprises at least one of revenue, profit, sales, sales leads, unaided brand awareness, intent to purchase, perceived relevance, or a combination thereof.

3. The method of claim 1, wherein the linear problem comprises a linear optimization problem and solving comprises optimizing the marketing objective.

4. The method of claim 1, wherein each of the plurality of marketing allocation options comprises a marketing spending option.

5. The method of claim 1, wherein the plurality of marketing allocation options identify how a resource is to be apportioned among one or more marketing techniques.

6. The method of claim 1, wherein one or more of the marketing allocation options comprise a marketing spending option that identifies how to apportion at least some marketing resources to one or more forms of advertising.

7. The method of claim 1, further comprising:
storing response data of the marketing metric versus one or more of the plurality of marketing allocation options in a fourth computer memory location; and
translating the response data to one or more piecewise linear response functions of the marketing metric versus one or more of the plurality of marketing allocation options.

8. The method of claim 7, wherein the piecewise linear response function of the marketing metric versus one or more of the marketing allocation options comprises the marketing metric as a function of a monetary amount of spending.

9. The method of claim 7, wherein translating the response data to the one or more piecewise linear response functions of the marketing metric versus one or more of the plurality of the marketing allocation options comprises mapping the response data, adjusting the response data to substantially similar units, and bounding the response data within a domain.

10. The method of claim 7, wherein translating the response data to the one or more piecewise linear response functions of a marketing metric versus one or more of the plurality of the marketing allocation options comprises identifying discrete endpoints for one or more linear intervals and expressing each of the one or more linear intervals in a weighted sum of products having weighting variables, substantially of the form:
ƒ(y)=ƒ(ŷ₁)x₁+ƒ(ŷ₂)x₂+ . . . +ƒ(ŷₖ)xₖ

11. The method of claim 10, wherein the summation of the weighting variables is less than or equal to a value of one, wherein not more than two of the weighting variables are non-zero, and wherein the not more than two of the weighting variables that are non-zero are adjacent to one another.

12. The method of claim 1, wherein providing a linear problem incorporating a special ordered set, comprises providing a linear problem incorporating a special ordered set of type two.

13. The method of claim 1, wherein providing a linear problem incorporating one or more special ordered sets and based at least in part on the stored marketing objective, one or more of the plurality of marketing allocation options, and the one or more piecewise linear response functions comprises providing an objective function based at least in part on the stored marketing objective or providing constraints based at least in part on one or more of the piecewise linear response functions or one or more of the plurality of marketing allocation options.

14. The method of claim 1, wherein providing a linear problem incorporating one or more special ordered sets and based at least in part on the stored marketing objective, one or more of the plurality of marketing allocation options, and the one or more piecewise linear response functions comprises providing constraints and designations to effect special ordered sets of type one for the allocation options that are mutually exclusive.

15. The method of claim 1, wherein solving the linear problem comprises using a linear program solver.

16. The method of claim 1, wherein the solution indicative of an apportionment of marketing resources among marketing allocation options is indicative of an estimated optimum apportionment of marketing resources to one or more of the plurality of marketing allocation options.

17. The method of claim 1, wherein solving the linear problem comprises providing a monetary spending amount for each of the plurality of marketing allocation options.

18. The method of claim 1, wherein the linear problem comprises a linear optimization problem, and wherein solving comprises minimizing spending and meeting goals for one or more metrics.

19. The method of claim 1, wherein the linear problem comprises a linear optimization problem and, wherein solving comprises meeting goals for at least one metric and optimizing at least one metric.

20. The method of claim 1, comprising allocating marketing resources based on the solution.

21. A computer readable storage medium comprising program instructions stored thereon, wherein the program instructions are computer-executable to implement a method of apportioning marketing resources, comprising:
storing a marketing objective for a marketing metric;
storing a plurality of marketing allocation options;
storing one or more piecewise linear response functions of the marketing metric versus one or more of the plurality of marketing allocation options;
providing a linear problem incorporating one or more special ordered sets and based at least in part on the stored marketing objective, one or more of the plurality marketing allocation options, and one or more of the piecewise linear response functions; and
solving the linear problem to generate a solution indicative of an apportionment of marketing resources that satisfies the marketing objective.

22. A system for determining an apportionment of marketing resources, comprising:
a CPU;
a data memory coupled to the CPU; and
a system memory coupled to the CPU, wherein the system memory is configured to store one or more computer programs executable by the CPU, and wherein the computer programs are executable to implement a method comprising:
storing a marketing objective for a marketing metric;
storing a plurality of marketing allocation options;
storing one or more piecewise linear response functions of the marketing metric versus one or more of the plurality of marketing allocation options;
providing a linear problem incorporating one or more special ordered sets and based at least in part on the stored marketing objective, one or more of the plurality marketing allocation options, and one or more of the piecewise linear response functions; and
solving the linear problem to generate a solution indicative of an apportionment of marketing resources that satisfies the marketing objective.

23. A method of apportioning marketing resources, comprising:
receiving one or more marketing objectives;
receiving a plurality of response functions indicative of marketing metric values as a function of a marketing allocation option;
translating one or more of the plurality of response functions each into a response function of a piecewise linear form;
providing a linear problem based at least in part on at least one of the one or more marketing objectives and one or more of the response functions of piecewise linear form;
providing the linear problem to linear programming solver software;
executing the linear programming solver software to solve the linear problem;
determining an actual allocation amount for one or more marketing allocation options associated with the plurality of response functions based on a solution of the linear problem; and
apportioning marketing resources based on the determined actual allocation amount for the one or more marketing allocation options associated with the plurality of response functions.

24. A method of apportioning marketing resources, comprising:
providing a marketing objective function;
providing a first response function for a metric comprising a first set of metric response values that correspond to a first set of allocation amounts for a first marketing allocation option;
translating the first response function into a piecewise linear form comprising a plurality of first linear components, wherein each of the plurality of first linear components comprises a discrete response function value for an associated allocation amount multiplied by a weighting variable, and wherein the summation of the weighting variables for each of the plurality of first linear components is less than or equal to a value of one;
providing a second response function for the metric comprising a second set of metric response values that correspond to a second set of allocation amounts for a second marketing allocation option;
translating the second response function into a piecewise linear form comprising a plurality of second linear components, wherein each of the plurality of second linear components comprises a discrete response function value for an associated allocation amount multiplied by a weighting variable, wherein the summation of the weighting variables for each of the plurality of second linear components is less than or equal to a value of one;
calculating a solution set using a special ordered set of type two based on the marketing objective function, comprising:
calculating a first plurality of solution values, wherein each of the first plurality of solution values corresponds to a weighting variable corresponding to each of the plurality of first linear components, wherein the summation of the weighting variables for each of the plurality of first linear components is less than or equal to a value of one, wherein not more than two the weighting variables for each of the plurality of first linear components are non-zero, and wherein the not more than two of the weighting variables for each of the plurality of first linear components that are non-zero are adjacent to one another when arranged with respect to their associated allocation amounts; and
calculating a second plurality of solution values, wherein each of the second plurality of solution values corresponds to a weighting variable corresponding to each of the plurality of second linear components, wherein the summation of the weighting variables for each of the plurality of second linear components is less than or equal to a value of one, wherein not more than two the weighting variables for each of the plurality of second linear components are non-zero, and wherein the not more than two of the weighting variables for each of the plurality of second linear components that are non-zero are adjacent to one another when arranged with respect to their associated allocation amounts; and
calculating an allocation solution, comprising:
calculating a first allocation solution for a first allocation option, comprising summing the products of each of the first plurality of solution values and an associated allocation amount of the first set of allocation amounts; and
calculating a second allocation solution for a second allocation option, comprising summing the products of each of the second plurality of solution values and an associated allocation amount of the second set of allocation amounts.

25. The method of claim 24, wherein the objective function comprises maximization of a summation of the first response function and the second response function for the metric.

26. The method of claim 24, wherein the objective function comprises minimization of a summation of the first allocation solution sum of products and the second allocation solution sum of products, and a goal for the summation of the first response function and the second response function for the metric to meet or exceed.
